(19) United States
(12) Patent Application Publication
(10) Pub. No.: US 2014/0372201 A1
(43) Pub. Date: Dec. 18, 2014

(54) PROMOTIONAL FORMS FOR ADVERTISING

(71) Applicant: Microsoft Corporation, Redmond, WA (US)

(72) Inventor: Jose D. Saura, Kent, WA (US)

(21) Appl. No.: 13/917,274

(22) Filed: Jun. 13, 2013

(51) Int. Cl. G06Q 30/02

(52) U.S. Cl. CPC G06Q 30/0273
USPC 705/14.41; 705/14.4; 705/14.69

(57) ABSTRACT

One or more techniques and/or systems are provided for generating a promotional form and/or for maintaining a promotional activity catalog. For example, a promotional activity catalog comprising one or more promotional activities may be exposed to an advertiser entity (e.g., a restaurant business). A set of promotional activities selected from the promotional activity catalog may be identified (e.g., a coupon activity, a reserve table activity, a view slideshow activity, etc.). A promotional form, such as an interactive user interface, comprising promotional activity interfaces for the set of promotional activities may be generated. Monetization schemes may be associated with such promotional activity interfaces. In this way, the promotional form may comprise various promotional activities and/or monetization schemes. The promotional form may be presented to users to promote the advertiser entity (e.g., a user may reserve a table at the restaurant business through a reservation promotional activity interface within the promotional form).

### BACKGROUND

Many businesses may advertise services, consumer goods, and/or other items through electronic distribution channels. In an example, a social network may display car video advertisements (e.g., linking to a car website) to social network users that may have expressed an interest in cars. In another example, a web search app may display restaurant image advertisements (e.g., linking to a restaurant website) with search results related to food. In this way, businesses may utilize cost per click (CPC) and/or cost per impression (CPI) campaigns to attract users to existing websites maintained by such businesses. For example, a restaurant may pay the web search app a fee that is relative to a number of users that are redirected (e.g., by “clicking” on a restaurant image advertisement presented with search results provided by the web search app) to the restaurant website.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for generating a promotional form and/or for maintaining a promotional activity catalog are provided herein. For example, a promotional activity catalog may comprise one or more promotional activities that may be selectively incorporated into a promotional form as promotional activity interfaces. The promotional activity catalog may be maintained such that a provider entity (e.g., a restaurant reservation provider entity) may add support for new promotional activities. For example, a create promotional activity request may be received from the restaurant provider entity. The create promotional activity request may comprise a provider identifier for the restaurant reservation provider entity (e.g., information used to invoke restaurant reservation functionality provided by the restaurant reservation provider entity), the restaurant reservation promotional activity (e.g., restaurant reservation functionality exposed through a restaurant reservation promotional activity interface on a promotional form), a monetization scheme for the restaurant reservation promotional activity (e.g., the restaurant reservation provider entity may pay a referral fee when users utilize the restaurant reservation promotional activity interface because the restaurant reservation provider entity may have separate fee arrangements with restaurants), and/or other information such as activity interface information used to display the restaurant reservation promotional activity interface for the restaurant reservation promotional activity. In this way, a new promotional activity, such as the restaurant reservation promotional activity, may be created within the promotional activity catalog to create an updated promotional activity catalog that may be exposed to advertiser entities for generation of promotional forms (e.g., exposure to a restaurant business that may desire to promote/advertise a restaurant through a restaurant promotional form).

In an example of generating a promotional form, the promotional activity catalog may be exposed. For example, the promotional activity catalog may be exposed through a promotional form development interface (e.g., a development environment hosted by an application or a website, which may allow advertiser entities to dynamically create customized promotional forms to advertise/promote their business) to an advertiser entity such as the restaurant business seeking to promote the restaurant. A set of promotional activities selected from the promotional activity catalog may be identified. For example, the restaurant business may select a slideshow promotional activity, a coupon promotional activity, and/or the restaurant reservation promotional activity. A promotional form may be generated to comprise promotional activity interfaces for the set of promotional activities (e.g., interactive user interfaces comprising images, text, and/or functionality used to perform promotional activities), such as a slideshow promotional activity interface, a coupon promotional activity interface, and/or a restaurant reservation promotional activity interface. In an example, monetization schemes, comprising one or more types of charges, may be assigned to the promotional activities associated with the promotional activity interfaces (e.g., an advertiser charge where the restaurant business is charged for utilization of the coupon promotional activity interface; a provider charge where the restaurant reservation promotional service is charged a referral fee for utilization of the restaurant reservation promotional activity interface; and/or a advertiser pass through charge where the restaurant business is charged an amount associated with utilization of the slideshow promotional activity interface, which may be paid to a slideshow creation service that performs the slideshow promotional activity).

In an example, the promotional form may comprise an interactive interface (e.g., displayed through a web browser, a website, an application, a user interface, etc.) through which a user may interact with promotional activity interfaces. Responsive to a selection of a promotional activity interface, a corresponding promotional activity may be performed. For example, the restaurant reservation provider entity may be invoked to perform the restaurant reservation promotional activity based upon a user interacting with the restaurant reservation promotional activity interface (e.g., a reservation time, a party size, and/or other information received from the user through the restaurant reservation promotional activity interface may be passed to the restaurant reservation provider entity). A monetization scheme associated with the restaurant reservation promotional activity may be implemented to track performance of the restaurant reservation promotional activity for billing purposes. In this way, a promotional form, comprising one or more promotional activity interfaces for promotional activities that may be performed by one or more provider entities and/or associated with one or more monetization schemes, may be generated for an advertiser entity.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of generating a promotional form.

FIG. 2 is an illustration of an example of a promotional activity catalog.

FIG. 3 is an illustration of an example of customizing a promotional activity.

FIG. 4 is a component block diagram illustrating an exemplary system for generating a promotional form.

FIG. 5 is an illustration of an example of billing sheets for a restaurant promotional form.

FIG. 6 is a flow diagram illustrating an exemplary method of maintaining a promotional activity catalog.

FIG. 7 is an illustration of an exemplary computer readable medium wherein processor-executable instructions configured to embody one or more of the provisions set forth herein may be comprised.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

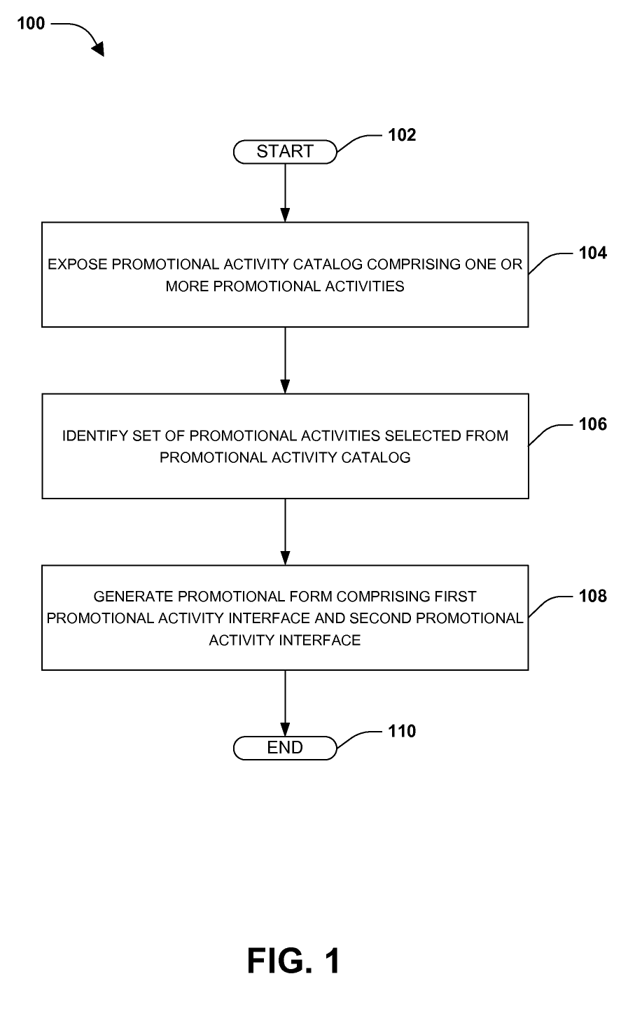

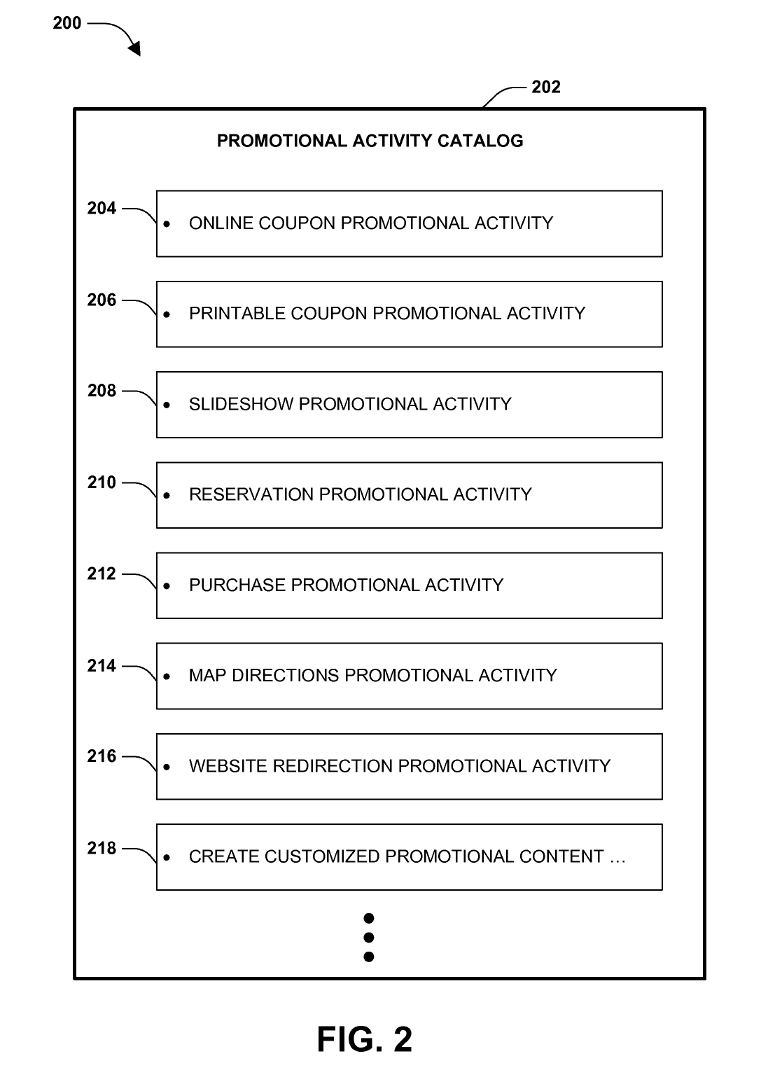

An embodiment of generating a promotional form is illustrated by an exemplary method 100 of FIG. 1. At 102, the method starts. At 104, a promotional activity catalog comprising one or more promotional activities may be exposed. For example, the promotional activity catalog may be exposed to an advertiser entity, such as a business, for creation of a promotional form comprising an interactive interface through which the business may promote/advertise goods, services, and/or the business by allowing users to engage in promotional activities. A promotional activity may correspond to a wide variety of activities that may engage users while promoting the advertiser entity, such as a coupon redemption activity, a redirection to a website, displaying a multimedia interface (e.g., a car driving advertisement game), playing a movie (e.g., a visual car advertisement), playing an audio clip (e.g., an audio car advertisement), invoking functionality of a provider entity (e.g., buy basketball tickets through a ticket provider entity, make a restaurant reservation through reservation provider entity, order pizza through a food ordering provider entity, map directions through a map provider entity, create and/or display a slideshow created by a multimedia provider entity, purchase a product through a credit card transaction provider entity, and/or any other types of functionality that may be provided by a provider entity), and/or a wide variety of other actions that may engage a user and/or promote the advertiser entity. It may be appreciated that a non-limiting example of a promotional activity catalog 202 is illustrated in FIG. 2.

At 106, a set of promotional activities selected from the promotional activity catalog may be identified. For example, an advertiser entity, such as a movie theater business, may have selected the set of promotional activities through a promotional form development interface (e.g., a development environment hosted by an application or a website, which may allow advertiser entities to dynamically create customized promotional forms to advertise/promote their business). In an example, the set of promotional activities may comprise a first promotional activity (e.g., a coupon promotional activity), a second promotional activity (e.g., a ticket ordering promotional activity), and/or other promotional activities that the movie theater business may want to include within the promotional form.

At 108, a promotional form, such as a movie theater promotional form, may be generated to comprise a first promotional activity interface for the first promotional activity, a second promotional activity interface for the second promotional activity, and/or other promotional activity interfaces for other promotional activities within the set of promotional activities. For example, a coupon promotional activity interface may comprise a coupon image describing details of the coupon, functionality used to redeem the coupon, and/or other information and/or functionality associated with the coupon promotional activity. A ticket ordering promotional activity interface may comprise an interface through which a user may enter ticketing information (e.g., a movie name, selection of a movie time, a number of tickets, etc.) and/or invoke ticket ordering functionality provided by a ticketing provider entity. In this way, the promotional form may comprise a variety of promotional activity interfaces that may appeal to various users.

In an example, a promotional activity interface may be customized based upon one or more customization parameters (e.g., selected by the advertiser entity through the promotional form development interface). A customization parameter may comprise an image (e.g., a coupon image), a selection of a provider entity to perform a promotional activity (e.g., a selection of a coupon redemption provider entity), an input parameter for performance of a promotional activity (e.g., a coupon bar code), textual information to display through a promotional activity interface (e.g., a coupon description), and/or a variety of other information.

In an example, a customized activity interface (e.g., a promotional activity interface not comprised within the promotional activity catalog) may be generated for inclusion within the promotional form. For example, the movie theater business may submit a customized promotional content comprising a textual description of the movie theater, an image of the movie theater, and a link to a historical website providing additional details about the movie theater. The customized promotional content may be used to generate a customized activity interface that may be included within the movie theater promotional form.

Various monetization schemes may be associated with promotional activity interfaces within the promotional form. For example, responsive to selection of a promotional activity from the promotional activity catalog, one or more monetization schemes and/or an ability to create a new monetization scheme may be exposed for association with a promotional activity interface for the promotional activity. In an example, a first monetization scheme may correspond to an advertiser charge associated with the advertiser entity (e.g., the movie theater business may be charged a fee proportional to user utilization of the coupon promotional activity interface). In another example, a second monetization scheme may correspond to a provider charge associated with a provider entity that provides a service for a promotional activity (e.g., the ticketing provider entity may be charged a “referral” fee for users directed to the ticketing provider entity through the ticket ordering promotional activity interface). In another example, a third monetization scheme may correspond to an advertiser pass through charge associated with a charge to an advertiser entity that is paid to a provider entity that provides a service/functionality for performing a promotional activity (e.g., the movie theater business may be charged a fee that may be paid to the coupon redemption provider entity when a user redeems a coupon through the coupon promotional activity interface). In an example, a promotional activity interface may be associated with a monetization scheme that may charge fees to multiple entities (e.g., the advertiser entity and a provider entity may be charged for utilization of a promotional activity interface). In this way, promotional activity interfaces within the promotional form may be associated with a variety of monetization schemes that may be managed for various entities, such as the advertiser entity and/or provider entities.

The promotional form may be exposed to users through websites, search results, a social network, an application, and/or other user interfaces. Responsive to selection of a promotional activity interface, a corresponding promotional activity may be performed and/or a corresponding monetization scheme may be implemented. For example, a provider entity may be invoked to perform the corresponding promotional activity. In an example, responsive to a user interacting with the ticket ordering promotional activity interface (e.g., specifying a movie name, a movie time, a number of seats, etc.), the ticketing provider entity may be invoked to perform the ticket ordering promotional activity, and a result of the ticketing ordering promotional activity may be recording within one or more billing sheets according to a monetization scheme associated with the ticket ordering promotional activity interface. At 110, the method ends.

FIG. 2 illustrates an example 200 of a promotional activity catalog 202. It may be appreciated that the promotional activity catalog 202 is merely a simple example of a promotional activity catalog used for illustrative purposes and that a variety of other information may be comprised within a promotional activity catalog. The promotional activity catalog 202 may comprise one or more promotional activities that may be selected by an advertiser entity for generation of a promotional form used to promote the advertiser entity. For example, the promotional activity catalog 202 may comprise an online coupon promotional activity 204 (e.g., a user may be directed to an online coupon redemption provider entity), a printable coupon promotional activity 206 (e.g., a user may print a coupon from a promotional form), a slideshow promotional activity 208 (e.g., a multimedia provider entity may create a slideshow from images provided by the advertiser entity for display through a promotional form), a reservation promotional activity 210 (e.g., a reservation provider entity may provide functionality to reserve restaurant seats, movie tickets, etc.), a purchase promotional activity 212 (e.g., a purchasing provider entity may provide functionality for a user to purchase an item through a promotional form), a map directions promotional activity 214 (e.g., a user may be directed to a map website with directions to the advertiser entity), a website redirection promotional activity (e.g., a user may be redirected to a website of the advertiser entity), and/or other promotional activities. The promotional activity catalog 202 may comprise a create customized promotional content function 218 that may be used by the advertiser entity to create a customized activity interface for inclusion within a promotional form. The promotional activity catalog 202 may be exposed to the advertiser entity, such as a restaurant business, for selection of a set of promotional activities (e.g., one or more promotional activities) used to generate a promotional form such as a restaurant promotional form.

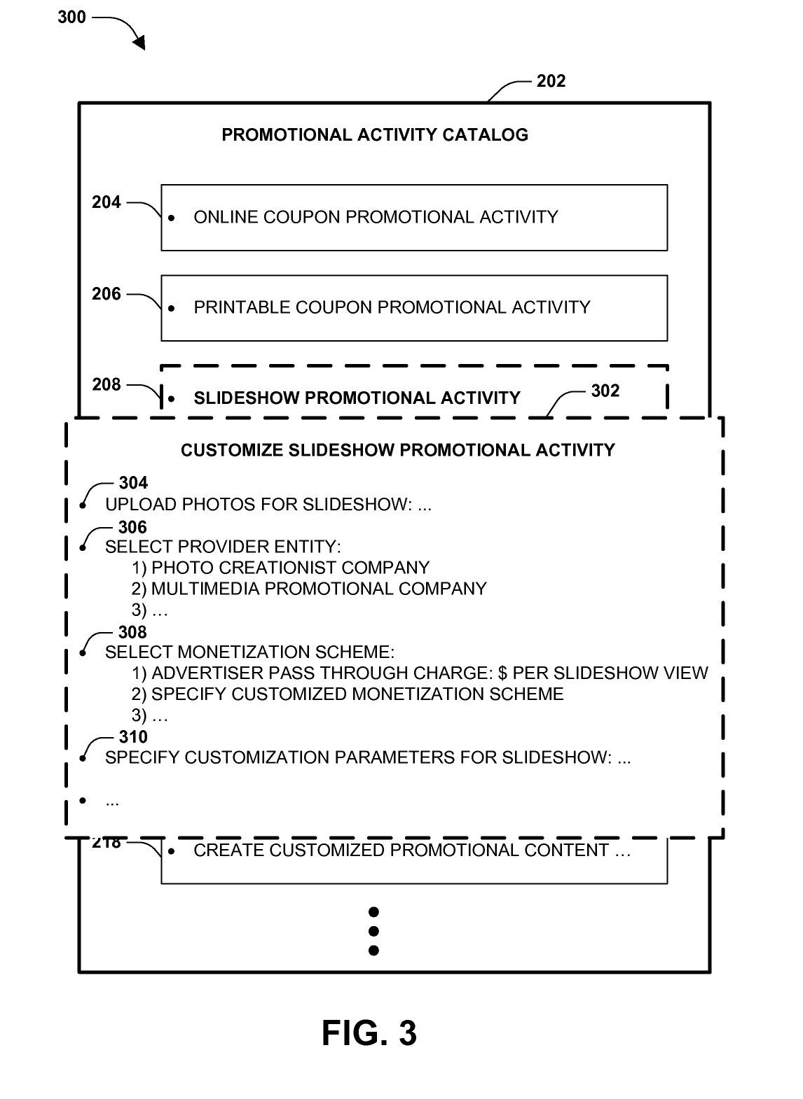

FIG. 3 illustrates an example 300 of customizing a promotional activity. In an example, a promotional activity catalog 202 may have been exposed to an advertiser entity, such as a restaurant business, for creation of a promotional form (e.g., FIG. 2). Responsive to selection of a slideshow promotional activity 208, a customization interface 302 may be exposed. The customization interface 302 may allow the advertiser entity to customize a slideshow promotional activity interface that may be included within the promotional form. For example, the advertiser entity may upload 304 photos for the slide show, select 306 a provider entity to perform the slide show promotional activity 208 (e.g., create a slideshow of the restaurant), select or create 308 a monetization scheme for the slideshow promotional activity interface (e.g., the restaurant business may be charged, according to an advertiser pass through charge, per slideshow viewed by user), and/or specify 310 customization parameters for the slide show promotional activity 208 (e.g., a length of the slideshow, textual information to display, a transition time between images, music, etc.). In this way, the advertiser entity may customize promotional activity interfaces included within the promotional form.

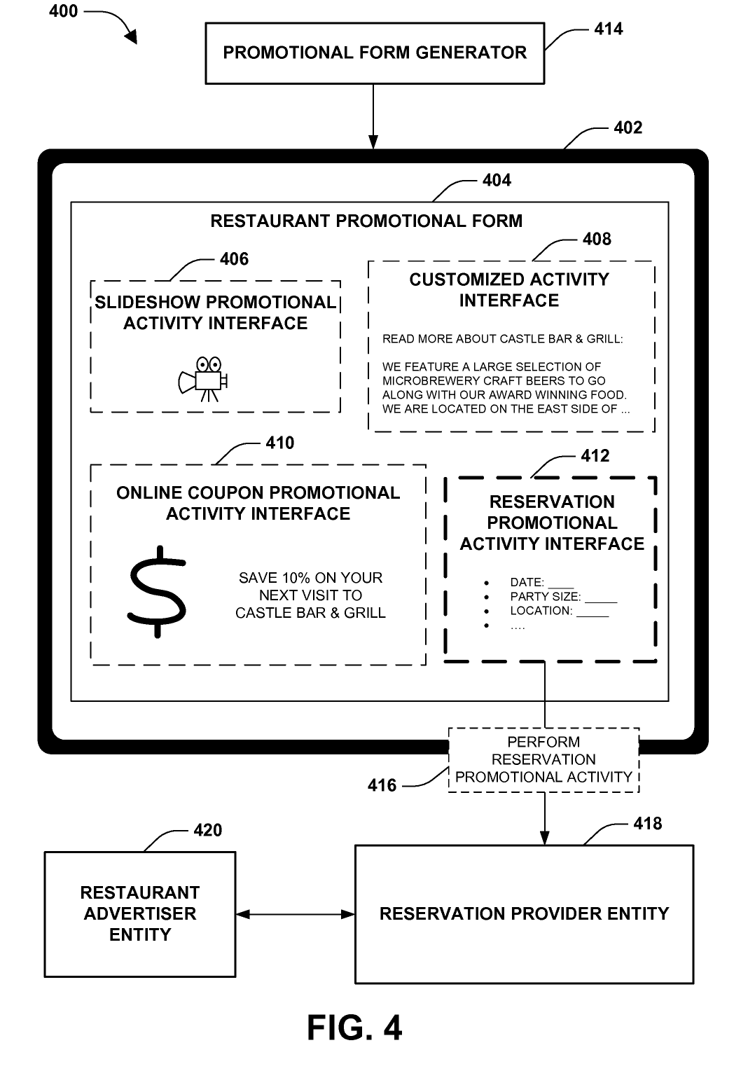

FIG. 4 illustrates an example of a system 400 for generating a promotional form. The system 400 may comprise a promotional form generator 414. The promotional form generator 414 may be configured to expose a promotional activity catalog comprising one or more promotional activities (e.g., promotional activity catalog 202 of FIG. 2). For example, the promotional form generator 414 may expose the promotional activity catalog to an advertiser entity, such as a restaurant business represented as the restaurant advertiser entity 420. The promotional form generator 414 may be configured to identify a set of promotional activities selected from the promotional activity catalog. For example, the restaurant business may have selected a slideshow promotional activity, an online coupon promotional activity, and/or a reservation promotional activity. In an example, the restaurant business may have specified customized promotional content used to generate a customized activity interface 408. The restaurant business may have provided customization parameters for one or more of the promotional activities (e.g., images to display through a slideshow promotional activity interface 406, coupon text to display through an online coupon promotional activity interface 410, etc.). The restaurant business may have selected and/or specified monetization schemes for the promotional activities. In this way, the promotional form generator 414 may create a restaurant promotional form 404 comprising the slideshow promotional activity interface 406 for the slideshow promotional activity, the online coupon promotional activity interface 410 for the online coupon promotional activity, a reservation promotional activity interface 412 for the reservation promotional activity, and/or the customized activity interface 408 for the customized promotional content.

The restaurant promotional form 404 may be exposed to a user, such as through a device 402, such as a tablet device, a mobile device, a desktop device, etc. (e.g., the restaurant promotional form 404 may be presented through a website, search results, an application, and/or a user interface hosted by the device 402). The user may have an interest in making dinner reservations at the restaurant business. Accordingly, the user may interact with the reservation promotional activity interface 412 to perform the reservation promotional activity (e.g., the user may specify a date, a party size, a location, and/or other information used to perform the reservation promotional activity). A reservation provider entity 418, comprising restaurant reservation functionality, may be invoked 416 to perform the reservation promotional activity. For example, the reservation provider entity 418 may submit a reservation to the restaurant advertiser entity 420. A monetization scheme for the reservation promotional activity interface 412 may be implemented (e.g., the reservation provider entity 418 may be charged a “referral fee” and/or the restaurant advertiser entity 420 may be charged a utilization fee).

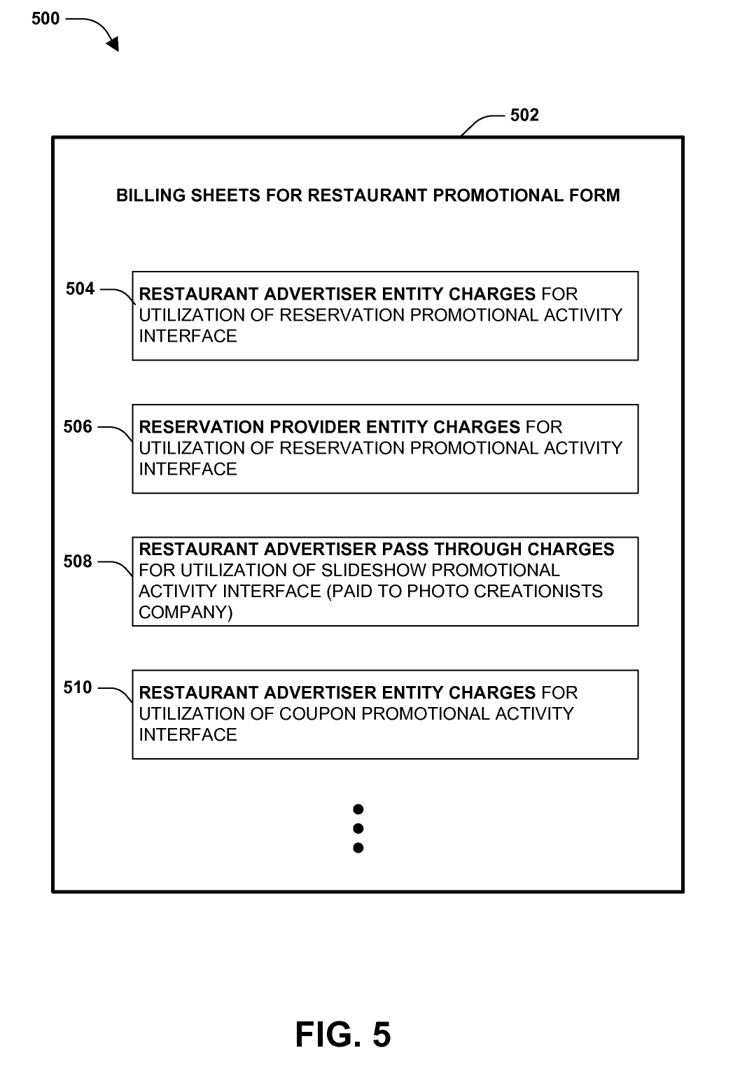

FIG. 5 illustrates an example 500 of billing sheets 502 for a restaurant promotional form. In an example, the billing sheets 502 may be generated for the restaurant promotional form 404 of FIG. 4 based upon various utilization metrics associated with users utilizing promotional activity interfaces. In an example, the billing sheets 502 comprise a first billing sheet 504 corresponding to restaurant advertiser entity charges for utilization of a reservation promotional activity interface (e.g., utilization of the reservation promotional activity interface 412 of FIG. 4). A second billing sheet 506 may correspond to reservation provider entity charges for utilization of the reservation promotional activity interface (e.g., a referral fee for utilization of the reservation promotional activity interface 412 of FIG. 4). A third billing sheet 508 may correspond to restaurant advertiser pass through charges for utilization of a slideshow promotional activity interface, where such charges may be paid to a photo creationist company that performs a slideshow promotional activity for the slideshow promotional activity interface (e.g., slideshow promotional activity interface 406 of FIG. 4). A fourth billing sheet 510 may correspond to restaurant advertiser entity charges for utilization of a coupon promotional activity interface (e.g., online coupon promotional activity interface 410 of FIG. 4). In this way, monetization may be managed for various entities, such as the restaurant advertiser entity and/or provider entities.

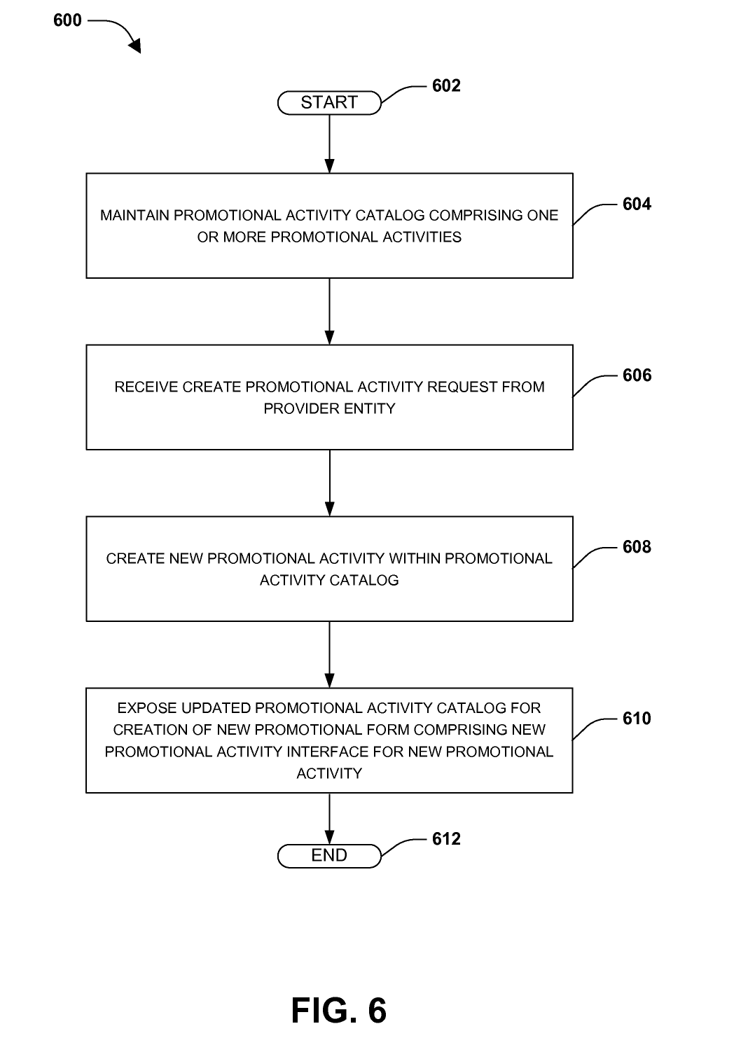

An embodiment of maintaining a promotional activity catalog is illustrated by an exemplary method 600 of FIG. 6. At 602, the method starts. At 604, a promotional activity catalog comprising one or more promotional activities for selective incorporation into a promotional form as promotional activity interfaces may be maintained (e.g., promotional activity catalog 202 of FIG. 2). The promotional activity catalog may be maintained by adding, removing, and/or modifying promotional activities within the promotional activity catalog. At 606, a create promotional activity request may be received from a provider entity (e.g., a 3D panorama creation provider entity comprising functionality for creating and/or hosting a 3D panorama). The create promotional activity request may comprise a provider identifier for the provider entity (e.g., an identifier, such as a URL or a web service identifier, used to invoke the 3D panorama creation provider entity to perform a 3D panorama promotional activity), a new promotional activity supported by the provider entity (e.g., information regarding the 3D panorama promotional activity), a new monetization scheme for the new promotional activity (e.g., costs and/or parameters associated with utilization of 3D panorama functionality provided by the 3D panorama creation provider entity), and/or new activity interface information for generation of a new activity interface for the new promotional activity (e.g., user interface elements, such as text, images, etc., for display through a 3D panorama promotional activity interface).

At 608, the new promotional activity may be created within the promotional activity catalog based upon the create promotional activity request to create an updated promotional activity catalog. At 610, the updated promotional activity catalog may be exposed for creation of a new promotional form. For example, an advertiser entity may select the new promotional activity for inclusion within the new promotional form as a new promotional activity interface. At 612, the method ends.

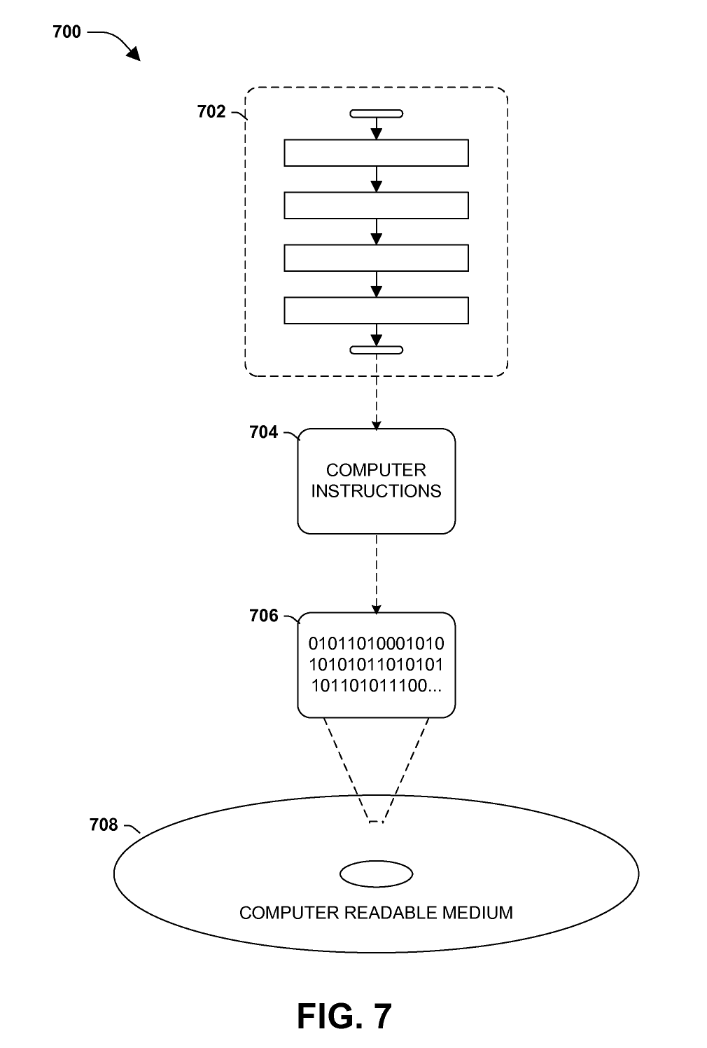

Still another embodiment involves a computer-readable medium comprising processor-executable instructions configured to implement one or more of the techniques presented herein. An example embodiment of a computer-readable medium or a computer-readable device that is devised in these ways is illustrated in FIG. 7, wherein the implementation 700 comprises a computer-readable medium 708, such as a CD-R, DVD-R, flash drive, a platter of a hard disk drive, etc., on which is encoded computer-readable data 706. This computer-readable data 706, such as binary data comprising at least one of a zero or a one, in turn comprises a set of computer instructions 704 configured to operate according to one or more of the principles set forth herein. In some embodiments, the processor-executable computer instructions 704 are configured to perform a method 702, such as at least some of the exemplary method 100 of FIG. 1 and/or at least some of the exemplary method 600 of FIG. 6, for example. In some embodiments, the processor-executable instructions 704 are configured to implement a system, such as at least some of the exemplary system 400 of FIG. 4, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

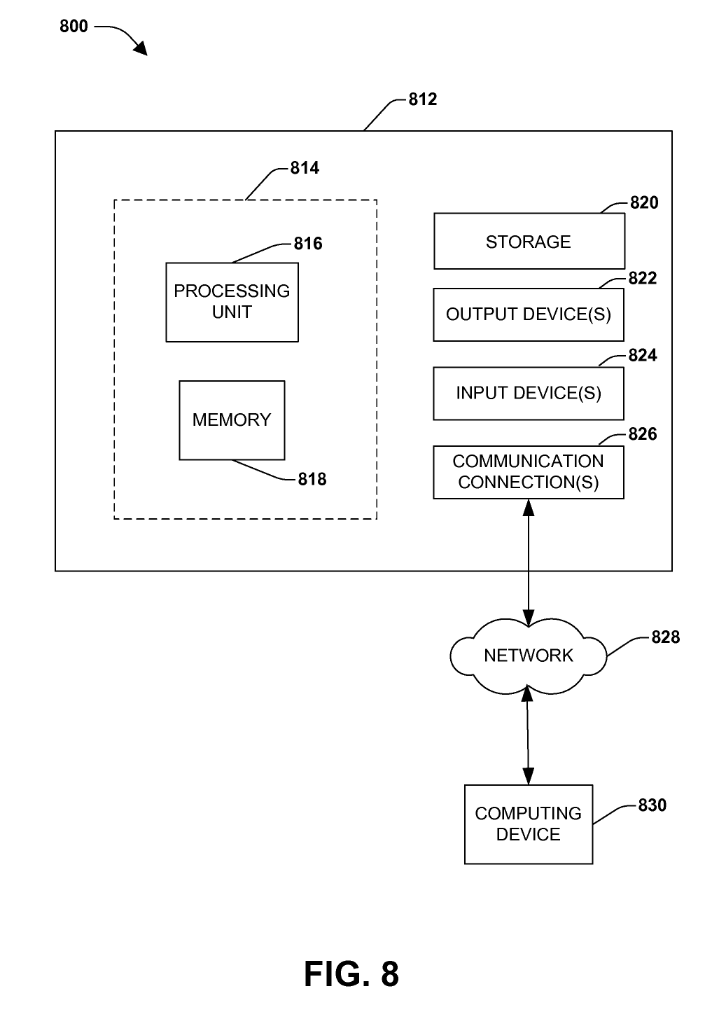

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 800 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via a network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application.

What is claimed is:

1. A method for generating a promotional form, comprising:
exposing a promotional activity catalog comprising one or more promotional activities;
identifying a set of promotional activities selected from the promotional activity catalog, the set of promotional activities comprising a first promotional activity and a second promotional activity; and
generating a promotional form comprising a first promotional activity interface for the first promotional activity and a second promotional activity interface for the second promotional activity, the first promotional activity interface different than the second promotional activity interface.

2. The method of claim 1, the identifying a set of promotional activities comprising:
responsive to a selection of the first promotional activity from the promotional activity catalog, exposing one or more monetization schemes; and
responsive to a selection of a first monetization scheme from the one or more monetization schemes, associating the first monetization scheme with the first promotional activity interface.

3. The method of claim 1, the first promotional activity interface associated with a first monetization scheme and the second promotional activity interface associated with a second monetization scheme, the first monetization scheme different than the second monetization scheme.

4. The method of claim 3, the first monetization scheme corresponding to an advertiser charge associated with an advertiser entity for which the promotional form is generated, and the second monetization scheme corresponding to a provider charge associated with a provider entity that provides a service for the second promotional activity.

5. The method of claim 3, the first monetization scheme corresponding to an advertiser charge associated with an advertiser entity for which the promotional form is generated, and the second monetization scheme corresponding to an advertiser pass through charge associated with a charge to the advertiser entity that is paid to a provider entity that provides a service for the second promotional activity.

6. The method of claim 3, the first monetization scheme corresponding to a provider charge associated with a provider entity that provides a service for the first promotional activity, and the second monetization scheme corresponding to an advertiser pass through charge associated with a charge to an advertiser entity that is paid to a second provider entity that provides a second service for the second promotional activity.

7. The method of claim 1, comprising:
receiving customized promotional content;
generating a customized activity interface for the customized promotional content; and
including the customized activity interface within the promotional form.

8. The method of claim 1, comprising:
receiving a first customization parameter for the first promotional activity; and
applying the first customization parameter to the first promotional activity interface.

9. The method of claim 8, the first customization parameter comprising at least one of an image, a selection of a provider entity to perform the first promotional activity, an input parameter for performance of the first promotional activity, or textual information to display through the first promotional activity interface.

10. The method of claim 1, comprising:
exposing the promotional form through at least one of a website, a search engine, a social network, an application, or a user interface.

11. The method of claim 1, comprising:
responsive to a selection of the first promotional activity interface, facilitating performance of the first promotional activity.

12. The method of claim 1, comprising:
responsive to a selection of the first promotional activity interface, implementing a first monetization scheme associated with the first promotional activity.

13. The method of claim 1, the first promotional activity corresponding to at least one of a coupon redemption, a redirection to a website, displaying a multimedia interface, playing a movie, playing an audio clip, or invoking a first provider entity to perform the first promotional activity.

14. The method of claim 1, comprising:
generating a set of billing sheets based upon user interaction with the promotional form, the set of billings sheets comprising a first billing sheet, a second billing sheet, and a third billing sheet, the first billing sheet corresponding to a first set of charges to an advertiser entity for which the promotional form was generated, the second billing sheet corresponding to a second set of charges to a first provider entity associated with a first group of promotional activities within the set of promotional activities, and the third billing sheet corresponding to a third set of charges to a second provider entity associated with a second group of promotional activities within the set of promotional activities.

15. A system for generating a promotional form, comprising:
a promotional form generator configured to:
expose a promotional activity catalog comprising one or more promotional activities;
identify a set of promotional activities selected from the promotional activity catalog, the set of promotional activities comprising a first promotional activity and a second promotional activity; and
generate a promotional form comprising a first promotional activity interface for the first promotional activity and a second promotional activity interface for the second promotional activity, the first promotional activity interface different than the second promotional activity interface.

16. The system of claim 15, the promotional form generator configured to:
responsive to a selection of the first promotional activity from the promotional activity catalog, expose one or more monetization schemes; and
responsive to a selection of a first monetization scheme from the one or more monetization schemes, associate the first monetization scheme with the first promotional activity interface.

17. The system of claim 15, the first promotional activity interface associated with a first monetization scheme and the second promotional activity interface associated with a second monetization scheme, the first monetization scheme different than the second monetization scheme.

18. The system of claim 15, the promotional form generator configured to:
expose the promotional form through at least one of a website, a search engine, a social network, an application, or a user interface.

19. The system of claim 15, the promotional form generator configured to:
responsive to a selection of the first promotional activity interface, implement a first monetization scheme associated with the first promotional activity.

20. A computer readable medium comprising instructions which when executed at least in part via a processing unit perform a method for maintaining a promotional activity catalog, comprising:
maintaining a promotional activity catalog comprising one or more promotional activities for selective incorporation into a promotional form as promotional activity interfaces;
receiving a create promotional activity request from a provider entity, the create promotional activity request comprising a provider identifier for the provider entity, a new promotional activity supported by the provider entity, a new monetization scheme for the new promotional activity, and new activity interface information for generation of a new promotional activity interface for the new promotional activity;
creating the new promotional activity within the promotional activity catalog based upon the create promotional activity request to create an updated promotional activity catalog; and
exposing the updated promotional activity catalog for creation of a new promotional form comprising the new promotional activity interface for the new promotional activity.
